(19) United States
(12) Patent Application Publication
(10) Pub. No.: US 2024/0020019 A1
(43) Pub. Date: Jan. 18, 2024

(54) RESUMABLE TRANSFER OF VIRTUAL DISKS

(71) Applicant: VMware, Inc., Palo Alto, CA (US)

(72) Inventors: Oleg Zaydman, San Jose, CA (US); Steven Schulze, Clayton, CA (US); Arunachalam Ramanathan, Union City, CA (US)

(21) Appl. No.: 17/866,319

(22) Filed: Jul. 15, 2022

(51) Int. Cl. G06F 3/06

(52) U.S. Cl. CPC G06F 3/0619; G06F 3/065; G06F 3/0664; G06F 3/0673

(57) ABSTRACT

Techniques for resuming a failed data transfer of a virtual disk between a source and destination are disclosed. In one set of embodiments, while the transfer is proceeding, metadata regarding the transfer, including an offset indicating transfer progress, may be periodically stored. Upon determining that the transfer has failed, a copy of the incomplete virtual disk at the destination (i.e., fragment) may be moved to a fragment storage and a record including an identifier of the virtual disk and the offset may be created and stored. At a later point in time, when transfer of the virtual disk is requested to be restarted, the request may be matched against the record to determine whether resumption of the prior transfer operation is possible. If so, the fragment can be moved to its original location at the destination and the transfer can be resumed based on the offset.

### BACKGROUND

Unless otherwise indicated, the subject matter described in this section is not prior art to the claims of the present application and is not admitted as being prior art by inclusion in this section.

Virtualization technology enables the creation of virtual instances of physical computer systems, known as virtual machines. Virtual machine mobility operations, such as transferring (e.g., moving or copying) virtual machines within and across datacenters, play a crucial role in managing modern virtual infrastructure. Transferring a virtual machine involves copying its virtual memory and/or virtual disks, and optionally deleting the source virtual machine in the case of a “move” operation. A virtual disk is one or more files or objects that hold persistent data used by a virtual machine.” Virtual disks may be stored a computer system or storage system and may be used virtual machine as if it were a standard disk. Operations which involve transferring virtual disks over a network are typically long running and may take tens of hours or more to complete. If a virtual disk transfer from a source to a destination fails while in-progress, some prior systems may delete the incomplete virtual disks at the destination as part of a cleanup operation. In such cases if the transfer operation is restarted, the virtual disk will need to be transferred again in its entirety, resulting in all of the work from the previous transfer operation being lost.

### BRIEF DESCRIPTION OF THE DRAWINGS

FIG. 1 depicts failure of a virtual disk transfer and resumption of the transfer according to certain embodiments.

FIG. 2 depicts a source system, a destination system, and a management system for transferring virtual disks and resuming failed transfers according to certain embodiments.

FIG. 3 depicts components of a source file copier, destination file copier, and fragment manager according to certain embodiments.

FIG. 4 depicts a flowchart for performing a virtual disk transfer and handling a failure of the transfer according to certain embodiments.

FIG. 5 depicts a flowchart for resuming a failed virtual disk transfer according to certain embodiments.

FIG. 6 depicts a conceptual diagram of a sparse disk format for virtual machines according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to techniques for transferring virtual disks and resuming failed transfers of virtual disks. When copying and transferring virtual disk data, the data can logically be separated into data which does not change during the operations (referred to as “cold data”) and data which does change (referred to as “hot data”). Certain embodiments of the present disclosure take advantage of the immutability of cold data to allow recovery from virtual disk transfer operation failure, thereby preventing loss of work. In one set of embodiments, these techniques can create a record of a partially transferred virtual disk, referred to as a “fragment,” at the time of a transfer failure. The record can then be used when the transfer of the virtual disk is restarted in order to identify the existing fragment and to resume the transfer operation from the prior point of failure using that fragment, thereby avoiding the need to re-transfer the entirety of the virtual disk.

### 2. High-Level Workflow

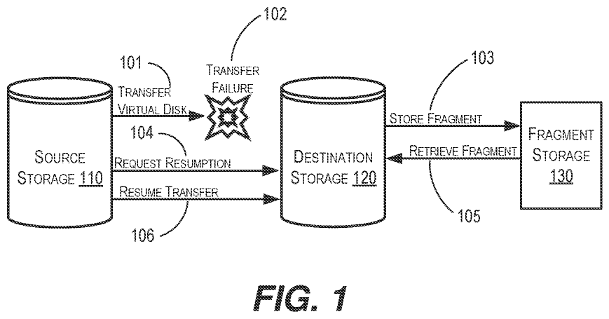

FIG. 1 depicts a high-level workflow illustrating a failed transfer of a virtual disk and resumption of that transfer according to certain embodiments. At step 101, a transfer of a virtual disk from a source storage 110 to a destination storage 120 can be initiated. As used herein, a “transfer” of a virtual disk refers to copying of the data of the virtual disk from one physical storage or memory location to another, over a network or locally. For instance, virtual disks may be transferred between two datastores. The labels of source and destination shown in FIG. 1 indicate the direction of the transfer. Source storage 110 and destination storage 120 may be located within the same computer system or they may be located in different systems communicatively coupled over a network. During the transfer, a destination system comprising destination storage 120 (not shown) may receive one or more portions of the virtual disk from a source system comprising source storage 110 (not shown). In these embodiments, the virtual disk that is transferred is a copy of a virtual disk stored at the source system.

At step 102, the transfer of the virtual disk can fail. This transfer failure may be caused by various circumstances. For instance, a network used to transfer the virtual disk may fail, reading of source storage 110 may fail, writing to destination storage 120 may fail, the source system hosting the source storage 110 may go down, the destination system hosting destination storage 120 may go down, the program code used to perform the transfer may lose permission to access either storage or network, etc.

The transfer failure may happen at any time and for various reasons. Given this situation, metadata regarding the virtual disk transfer, including an “offset,” can be tracked and periodically stored in destination storage 120 as the copying of the virtual disk from source storage 110 to destination storage 120 progresses. In one set of embodiments, the destination system may perform this tracking and storing based on the one or more portions of the virtual disk received from the source system. The offset indicates the number of logical data blocks of the virtual disk that have been copied so far during the virtual disk transfer. As the transfer progresses, the offset will increase.

Generally speaking, the metadata regarding the transfer is stored on a periodic basis because (1) the destination system may fail and have its memory reset, which would lose information that was not stored, and (2) writing the metadata continuously for every block transferred would incur a large I/O penalty, resulting in poor transfer performance. The period for which metadata is stored in destination storage 120 during the transfer may be based on a predefined number of blocks transferred since the last storage of metadata. For example, the transfer metadata, including the offset, may be stored or updated for every thousand blocks transferred. The metadata enables resumption of the transfer after the failure at step 102 because the transfer operation can be resumed based on the offset instead of the beginning of the virtual disk.

Once the transfer failure at step 102 occurs, it may be detected by a management system (not shown in FIG. 1), the destination system, or the source system. The management system may be capable of communicating with the destination system and may be configured to manage virtual disk storage and transfer across a plurality of computer systems.

In response to this detection, a fragment record can be created based on the metadata of the transfer. In various embodiments the fragment record includes, among other things, the offset and an identifier of a virtual disk “fragment” on destination storage 120 comprising the one or more virtual disk portions received from source storage 110. This fragment is the unfinished copy of the virtual disk left by the failed transfer, and thus comprises data copied/transferred to the destination storage 120 for the virtual disk transfer initiated at step 101. The fragment is preserved. For instance, the fragment may be moved to a fragment storage 130 or it may remain in the location where it was being copied to. At optional step 103, destination storage 120 may store the fragment in a fragment storage 130. Fragment storage 130 may be a logical location within destination storage 120, such as a particular directory, or a separate physical storage location.

At a later point in time, the destination system may receive a request to resume or restart the data transfer of the virtual disk (step 104). This request may include an identifier of the source virtual disk and may be made by the source system or by the management system. In some embodiments the request may be made by a different source system that maintains a copy of the same virtual disk that failed in transfer.

In response to the request, the destination system can determine whether it has a fragment record for the virtual disk identified in the request. If such fragment record exists, then the fragment of the virtual disk can be retrieved. In cases where the fragment was stored in the fragment storage 130, the fragment may be retrieved from the fragment storage 130 and moved back to its original location on destination storage 120 (optional step 105). This fragment retrieval may correspond to a physical or logical movement of the data.

If the fragment was stored in the fragment storage 130, once the fragment is moved back to its original location on destination storage 120, the source system can seek to the offset (stored in the fragment record) where the original transfer failed. To enable the source system to seek to this offset, the destination system may send a response to resume the data transfer of the virtual disk, where the response includes the offset. The source system can then resume the transfer of the virtual disk to destination storage 120 at step 106 based on the offset, thereby avoiding the need to re-transfer the portions of the virtual disk that were already transferred during the prior failed transfer operation.

### 3. Example Computing Environment

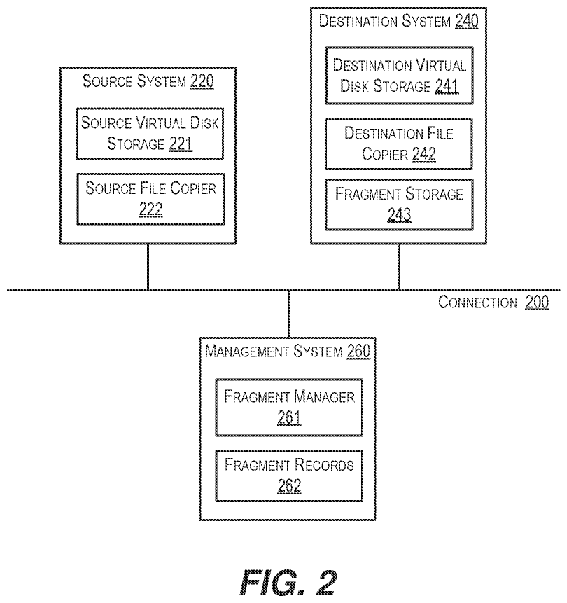

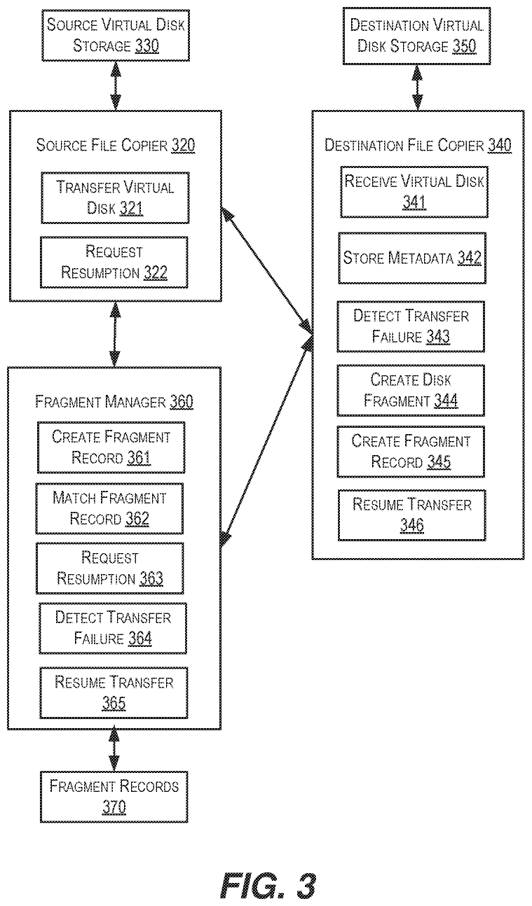

An overview of a virtual disk transfer between a source storage of a source system and a destination storage of a destination system and resumption of that transfer were described above with respect to FIG. 1. A management system was also described. Further details on these systems are given with respect to FIG. 2 below. The software and computer program code for performing the transfer and resumption are described below with respect to FIG. 3.

FIG. 2 depicts a source system 220, a destination system 240, and a management system 260 for transferring virtual disks and resuming failed transfers according to certain embodiments. These systems may be configured to operate as described above in FIG. 1.

Source system 220 may be configured to host zero or more virtual machines and store their virtual disks. Source system 220 includes a virtual disk storage 221 that stores the one or more virtual disks, which may be transferred in mobility operations. Source system 220 further includes a source file copier 222. Source file copier 222 is a software component configured to transfer virtual disks to destination system 240 or another system. Source file copier 222 is also configured to seek to a particular position of a stored virtual disk based on an offset and resume transfer from that position. Source file copier 222 is further described below with respect to FIG. 3.

Source system 220 may be communicatively coupled with the destination system and the management system over a connection 200. In some embodiments the connection 200 may comprise a network connection over a local area network or the Internet. In other embodiments connection 200 may comprise an electronic connection within a computer system or disk array. Connection 200 may include several communication devices, lines, and networks as required for communication. For instance, in a particular embodiment source system 220 and destination system 240 may be components within a single computer system and may communicate locally within that computer system while management system 260 may communicate with source system 220 and destination system 240 using a network.

Destination system 240 may be configured to host one or more virtual machines and store their virtual disks. Destination system 240 includes a destination virtual disk storage 241 that stores the one or more virtual disks, which may have been received in mobility operations. While labeled “source” and “destination” here, these labels simply refer to a particular transfer of a virtual disk. In other situations, the computer system that is labeled the destination system may be the source of a virtual disk being transferred and the computer system that is labeled the source system may be the receiver of a virtual disk being transferred. The destination system 240 optionally includes a fragment storage 243. After failure of the transfer is detected, the fragment may be preserved. In some embodiments preserving the fragment includes moving the fragment into the fragment storage 243. In some embodiments preserving the fragment involves leaving the fragment where it was in the destination virtual disk storage 241.

Destination system 240 further includes a destination file copier 242. Destination file copier 242 is a software component configured to receive virtual disks from source system 230 or another system. Source file copier 222 and destination file copier 242 may be components of the same software. Destination file copier 242 is also configured to seek to a particular position of a stored virtual disk based on an offset and resume storing of a virtual disk in a resumed transfer from that position. Destination file copier 242 is further described below with respect to FIG. 3.

Management system 260 includes a fragment manager 261 and one or more fragment records 262. Management system 260 may be configured to detect when transfer of a virtual disk has failed and it may identify a virtual disk fragment for the virtual disk on destination system 240 as well as create a fragment record for that fragment based on metadata of the failed transfer. In some embodiments the source file copier 222 and/or the destination file copier 242 may be configured to detect when transfer of the virtual disk has failed. In some embodiments fragment manager 261 and fragment records 262 may be implemented as part of destination system 240 rather than management system 260. That is, destination system 240 may manage the fragments and fragment records. Fragment manager 261 and fragment records 262 are further described below with respect to FIG. 3.

FIG. 3 depicts components of a source file copier 320, a destination file copier 340, and a fragment manager 360 according to certain embodiments. In various embodiments, source file copier 320, destination file copier 340, and fragment manager 360 may correspond to source file copier 222, destination file copier 242, and fragment manager 261 described above with respect to FIG. 2.

Source file copier 320 is a software component that can be executed by a source system. Source file copier 320 includes a transfer virtual disk component 321 and a request resumption component 322. Source file copier 320 is configured to access virtual disk storage 330. Source file copier 320 may also be configured to communicate with destination file copier 340 and fragment manager 360.

Destination file copier 340 is a software component that can be executed by a destination system. Destination file copier 340 includes a receive virtual disk 341 component, a store metadata 342 component, a detect transfer failure 343 component, a create disk fragment 344 component, a create fragment record component 345, and a resume transfer component 346. Destination file copier 340 is configured to access destination virtual disk storage 350 and fragment storage 380.

Fragment manager 360 is a software component that can be executed by a management system. Alternatively, in some embodiments fragment manager 360 may be executed by a destination system. As such, fragment manager 360 includes some of the same software components as destination file copier 340, although such components need not be duplicated in cases where the destination system performs fragment management. Fragment manager 360 includes a create fragment record 361 component, a match fragment record 362 component, a request resumption 363 component, a detect transfer failure 364 component, and a resume transfer 365 component.

As discussed above, the transfer of virtual disks can occasionally fail. Certain prior systems would delete the unfinished virtual disk from destination virtual disk storage 350 and then start the transfer over from the beginning. Instead of deleting the unfinished virtual disk, source file copier 320, destination file copier 340, and fragment manager 360 can work together to track the transfer by storing metadata, detect failure, create a virtual disk fragment and record of the fragment, and provide for resumption of the transfer based on the record as further described below.

The combination of transfer virtual disk 321 component of source file copier 320 and receive virtual disk 341 component of destination file copier 340 can read the virtual disk from the virtual disk storage 330, transfer the virtual disk over a connection (e.g., network), and write the virtual disk to destination virtual disk storage 350.

During the transfer of the virtual disk, store metadata 342 component can store metadata about the transfer.

Request resumption 322 component of source file copier 320 can send a request to destination file copier 340 to request resumption of a particular virtual disk transfer. The request can include an identifier of the source virtual disk to be transferred.

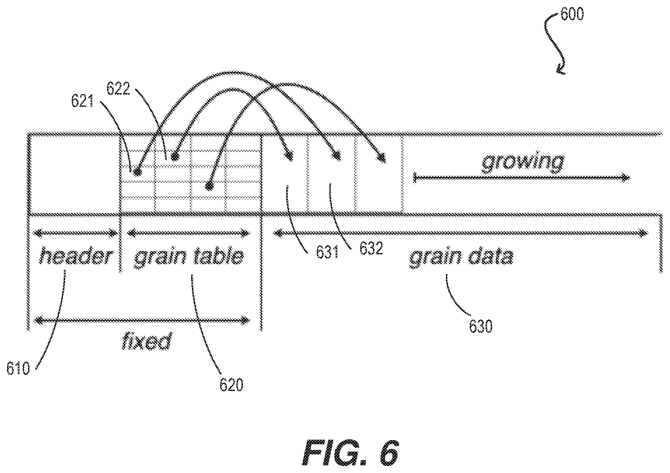

Store metadata 342 component of destination file copier 340 can track the virtual disk transfer and store metadata about the transfer. The metadata may include an offset (e.g., logical block offset of the virtual disk) as described above. The metadata may also include an elapsed time for the transfer. That is, how long the transfer was running before failure. As mentioned above, the metadata may be written or updated periodically (e.g., after a certain number of blocks have been transferred). Furthermore, the metadata may only be updated when the write has succeeded. In some embodiments the virtual disk may be stored using a format that requires multiple write operations to store data (e.g., write the data itself and write an update to a table or index). One such format is the “sparse disk format” described in further detail below with respect to FIG. 6.

Detect transfer failure 343 component of destination file copier 340 can determine whether the transfer of the virtual disk has failed. Failure may be detected based on an error, exception, or network disconnect, for example.

Create disk fragment 344 component of destination file copier 340 can identify one or more portions of a virtual disk that were received but where the virtual disk failed to completely transfer. These portions may be preserved. For instead, the portions may be stored together as a “fragment” upon detecting failure of the transfer. The fragment may be stored where it was during the transfer or it may be stored in a separate fragment storage. In some embodiments the portions of the virtual disk may be truncated based on the offset such that data past the offset is removed or deleted. The fragment may be truncated so that no data past the offset is present. The offset may be a logical offset. The relationship between logical offsets and physical offsets is complicated for virtual disks formatted as sparse disks, which are further described below. In some embodiments truncation may be performed upon retrieving the fragment instead.

Create fragment record component 345 of destination file copier 340 can create a record for a particular fragment based on metadata of the transfer of that virtual disk. This record may be stored as part of a group of fragment records 370. Fragment records 370 may be stored in a database of the management system or they may be stored as a separate file. In embodiments where fragment records 370 are stored in a separate file, they may be indexed to speed up search of a stored fragment (e.g., in response to a request for resumption of the transfer). Destination file copier 340 is configured to communicate with fragment manager 360 to perform these operations. The record may include a fragment identifier identifying the fragment and the corresponding virtual disk. The record may also include a timestamp of the record creation time, an identifier of destination virtual disk storage 350, an identifier of virtual disk storage 330, a path on the virtual disk storage 330 where the virtual disk is stored, and a format (e.g., flat format or sparse disk format) for storing the virtual disk at the destination. The record may also include a content identifier of the source virtual disk. This content identifier may be a unique identifier in the virtual disk's descriptor file that is a random number which is changed every time the virtual disk is opened for writing. The content identifier may be used to determine whether the virtual disk has been modified after the transfer failed such that the original transfer may not be resumed. The record may also include the elapsed time (i.e., time spent transferring). The record also includes the offset, which is described above.

The following table shows the schema for an example fragment record:

TABLE 1

| Name | Type |
|---|---|
| FRAGMENT_ID | BIGSERIAL |
| CREATION_TIME | TIMESTAMP |
| DEST_STORAGE_ID | BIGINT |
| SRC_STORAGE_ID | BIGINT |
| SRC_PATH | VARCHAR(255) |
| DEST_FORMAT_ID | BIGINT |
| CONTENT_ID | VARCHAR(16) |
| FRAGMENT_PATH | VARCHAR(255) |
| ELAPSED_TIME | BIGINT |
| OFFSET | BIGINT |

In this table, FRAGMENT_ID corresponds to an identifier of the stored fragment. CREATION_TIME corresponds to a timestamp of when the fragment record was created. The CREATION_TIME may be used to determine how old the fragment is for use in a fragment eviction process that frees up storage space in the fragment storage 380. DEST_STORAGE_ID corresponds to an identifier of the destination storage (e.g., an identifier of destination virtual disk storage 350). In certain embodiments, DEST_STORAGE_ID must match in order for the transfer to be resumed. That is, a failed transfer to one destination storage may not be resumed using another destination storage. SRC_STORAGE_ID corresponds to an identifier of the source storage (e.g., an identifier of source virtual disk storage 330). SRC_PATH corresponds to a filesystem path (e.g., on source virtual disk storage 330) where the source virtual disk is stored. SRC_STORAGE_ID and SRC_PATH together identify to source virtual disk and can be used to match a new request to transfer a source virtual disk with a failed transfer of that same source virtual disk. DEST_FORMAT_ID corresponds to a format (e.g., sparse disk format or flat format) to use for storing the received virtual disk at destination virtual disk storage 350. The destination format may be different from the format of the source virtual disk, however, the destination format for resumption should match the original destination format. CONTENT_ID refers to the unique random number that may be stored in a descriptor file and changed every time the virtual disk is opened for writing. The CONTENT_ID may be used to determine whether the source virtual disk changed since the original transfer was initiated. FRAGMENT_PATH refers to a filesystem path in fragment storage 380 where the fragment is stored. The FRAGMENT_PATH may be used to retrieve the fragment from fragment storage 380. ELAPSED_TIME corresponds to the amount of time that the transfer was running before it failed. The ELAPSED_TIME may be used as a parameter of a fragment eviction process where fragments having a shorter ELAPSED_TIME are selected for deletion when other parameters are equivalent. OFFSET corresponds to a number of blocks of the virtual disk that were transferred at the period in time when the metadata of the transfer was updated. The OFFSET may be used to determine where in the source virtual disk to resume the transfer.

Resume transfer component 346 of destination file copier 340 can receive a request for resumption (from request resumption 322 component of source file copier 320 or request resumption 363 component of fragment manager 360) identifying a particular source virtual disk and then initiate a check to determine whether a fragment exists for that virtual disk. The request for resumption may include one or more of the identifier of the source virtual disk, the identifier of virtual disk storage 330, the path on virtual disk storage 330 where the source virtual disk is stored, the format for storing the virtual disk at the destination, and the content identifier of the virtual disk. The identifier of the particular virtual disk may be a combination of the identifier of the source system and the path of the virtual disk on virtual disk storage 330.

Create fragment record 361 component of fragment manager 360 can perform similar operations for creating fragment records as create fragment record 345 component of destination file copier 340 to create records and store them in fragment records 370.

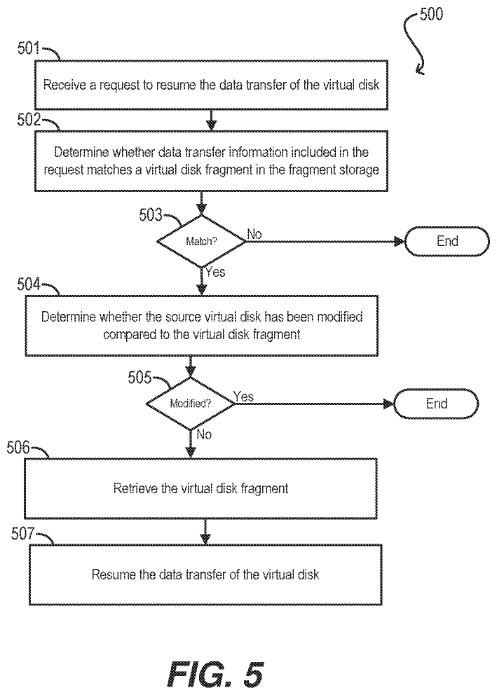

Match fragment record 362 component of fragment manager 360 is configured to check fragment records 370 to determine whether a fragment exists that corresponds to a requested transfer of a virtual disk. The requested transfer may be a request to resume or it may not specifically request resumption. Match fragment record 362 component may determine whether a storage identifier and a path in the transfer request match any of the identifiers of virtual disk storage 330 and corresponding path on virtual disk storage 330 in fragment records 370. The checks and matching performed in order to determine whether transfer can be resumed are further described below with respect to FIG. 5.

As mentioned above, fragment manager 360 may be part of the destination system or it may be part of a separate management system. Accordingly, fragment manager 360 may perform similar functionality as source file copier 320 and destination file copier 340. Request resumption 363 component of fragment manager 360 may be configured to perform similar operations as request resumption 322 component of source file copier 320. Detect transfer failure 364 component of fragment manager 360 may be configured to perform similar operations as detect transfer failure 343 component of destination file copier 340. Resume transfer 365 component of fragment manager 360 may be configured to perform similar operations as resume transfer 346 component of destination file copier 340.

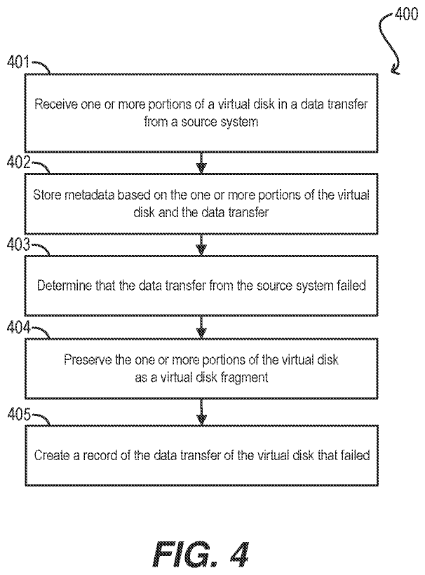

The operations performed by the software components of source file copier 320, destination file copier 340, and fragment manager 360 may be used to conduct virtual disk transfer, fragment storage, and record keeping as described below with respect to FIG. 4 as well as fragment matching and virtual disk transfer resumption as described below with respect to FIG. 5.

### 4. Virtual Disk Transfer and Resumption Process

FIG. 4 depicts a flowchart 400 of fragment storage and record keeping upon failure of a virtual disk transfer according to certain embodiments. The process shown in flowchart 400 may be implemented by the destination system and/or management system described above. Flowchart 400 may also be implemented as computer program code and instructions, such as in the form of the destination file copier and/or the fragment manager described above.

At 401, receive one or more portions of a virtual disk in a data transfer from a source system. The virtual disk may be a copy of a virtual disk stored at the source system. In some embodiments the virtual disk is formatted such that a physical representation of the virtual disk is different from a logical representation of the virtual disk. One format in which the logical representation and physical representation of the disk are not the same is the “sparse disk” format which, compared to flat disks (where logical and physical representation are the same), may use less physical storage as “grains” of data may be allocated on demand. A “grain” is a unit of storage comprising a group of blocks allocated in a single operation. A virtual disk formatted using sparse disk includes a header comprising information about the virtual disk, a grain table having entries pointing to individual grains of data, and the grain data itself. The sparse disk format, grain tables, and grain data are further described below with respect to FIG. 6.

At 402, store metadata pertaining to the one or more portions of the virtual disk copy and the data transfer. The metadata may include an offset as described above. The metadata may also include an elapsed time of the transfer as described above. The metadata, including the offset, may be updated periodically during the receiving of the one or more portions of the virtual disk. The offset may be updated to a number of logical blocks of the one or more portions of the virtual disk that have been received. An elapsed time may also be updated to the current amount of time elapsed during the transfer.

At 403, determine that the data transfer from the source system failed. The determination that the transfer failed may be based on an error or exception, a network connectivity condition, a timeout, or a determination that the source system or a destination storage has failed.

At 404, preserve the one or more portions of the virtual disk as a virtual disk fragment. In some embodiments the preservation as a fragment may involve leaving the one or more portions in the same location they were being transferred to while other embodiments may involve transferring the one or more portions of the virtual disk from a destination storage to a fragment storage. That is, store the virtual disk fragment including the one or more portions of the virtual disk in a fragment storage. The fragment storage may be a separate storage from the destination storage, either logically or physically. However, a physically separate fragment storage would take a longer time to move the fragments as move operations across storages is not a fast operation.

In some embodiments the receiving of the one or more portions of the virtual disk includes receiving data for an additional portion of the virtual disk beyond the one or more portions. For instance, the one or more portions may correspond to the buffer while the additional portion of the virtual disk corresponds to data beyond the buffer. In such cases the virtual disk fragment may further include the additional portion of the virtual disk. In some embodiments the process further includes truncating the virtual disk fragment including the one or more portions and the additional portion based on the offset to obtain a truncated virtual disk fragment including the one or more portions and not including the additional portion. That is, the additional portion is removed or deleted from the fragment. In some embodiments the additional portion of the virtual disk is not used when creating the fragment. The additional portion may be deleted after creating the fragment.

In some embodiments the truncating of the virtual disk fragment is performed after the determining that the data transfer failed and before the receiving of the request to resume the data transfer. The fragment may be truncated before being transferred to the fragment storage. In some embodiments the truncating of the virtual disk fragment is performed after the receiving of the request to resume the data transfer. The truncating may be performed before or after retrieving the fragment from fragment storage.

At 405, create a record of the data transfer of the virtual disk copy that failed. The record includes the offset and an identifier of a virtual disk fragment including the one or more portions of the virtual disk. The record may also include a timestamp of the record creation time. The record may include an identifier of the destination virtual disk storage, an identifier of the virtual disk storage, a path on the virtual disk storage where the virtual disk is stored, and a format (e.g., flat format or sparse disk format) for storing the virtual disk at the destination. The record may also include a content identifier of the virtual disk. The record may also include the elapsed time.

In some embodiments, the fragment may be selected for deletion based on its elapsed time (e.g., transfer time) and its age (e.g., time since the fragment was created), and then deleted from the fragment storage. The fragment may be selected based on an eviction/cleanup policy that groups the fragments according to gradations of age and then selects a certain number of fragments to delete having the shortest elapsed times.

FIG. 5 depicts a flowchart 500 of virtual disk transfer resumption according to certain embodiments. The process shown in flowchart 500 may be implemented by the destination system and/or management system described above. Flowchart 500 may also be implemented as computer program code and instructions, such as in the form of the destination file copier and/or the fragment manager described above.

At 501, receive a request to resume the data transfer of the virtual disk. The request can include the identifier of the virtual disk. The identifier of the virtual disk may be based on one or more of a source storage identifier and a source path.

At 502, determine whether data transfer information included in the request matches a virtual disk fragment in the fragment storage. The data transfer information included in the request may include a source storage identifier, a source path, a destination storage identifier, and a destination file format (e.g., sparse disk). This information may be compared against a fragment record identified using the identifier of the virtual disk.

At 503, it is determined whether the data transfer information included in the request matches corresponding information in the fragment record identified using the identifier of the virtual disk. If the information does not match (“NO” at 503) then the process ends and transfer resumption does not resume as the request is not compatible with the previously received and stored virtual disk. If the information matches (“YES” at 503) then the process proceeds to 504.

At 504, determine whether the source virtual disk has been modified compared to the virtual disk fragment. That is, the content identifier of the request is verified by matching it with the content identifier of the virtual disk. This determination may be based on a comparison of a content identifier included in the request (e.g., included in the data transfer information of the request) and a content identifier stored in the fragment record of the identified using the identifier of the virtual disk fragment. If the content identifier does not match then it may be determined that the source virtual disk has been modified since the previous failed transfer. As described above, the content identifier of a virtual disk may be changed when that disk is opened for write, indicating that the content of the virtual disk may have changed. If there is the possibility that the virtual disk changed then transfer may not be resumed because the virtual disk fragment may no longer be consistent with the source. If the content identifier in the request is the same as the content identifier of the corresponding fragment record, then it may be determined that the source virtual disk has not been modified since the transfer.

At 505, if the source virtual disk has been modified (“YES” at 505) then the process ends and resumption of transfer does not occur. If the source virtual disk has not been modified (“NO” at 505) then the process proceeds to 506.

At 506, retrieve the virtual disk fragment. Retrieval of the virtual disk fragment may involve transferring the one or more portions of the virtual disk to the destination storage from the fragment storage in embodiments where the virtual disk fragment was preserved in the fragment storage. That is, the virtual disk fragment is retrieved from the fragment storage in response to verification of the information in the request. In some embodiments the virtual disk fragment may be preserved in the location of the destination storage where it was stored during the failed transfer. As described above, the virtual disk fragment including the one or more portions may be truncated after being retrieved from the fragment storage and transferred to the destination storage.

At 507, resume the data transfer of the virtual disk. The data transfer may be resumed based on the offset included in the fragment record.

In some embodiments, a second request to resume a second data transfer may be received. The second request may include a second identifier of a second virtual disk and a second content identifier. A second virtual disk fragment corresponding to the second virtual disk may be identified based on the second identifier, but the second virtual disk fragment may have a third content identifier different from the second content identifier. In such cases the second virtual disk fragment may be deleted based on the third content identifier being different from the second content identifier.

### 5. Virtual Disk Data Fragment Deletion

Virtual disk fragments may be stored for use in resuming transfers as discussed above. However, not all transfers may be resumed. In some cases the virtual disk has been modified and so transfer is not possible. As storage is not infinite there becomes a time when older fragments should be deleted (“evicted”) to clear up storage space. However, there is the concern of deciding which fragments would be deleted in order to minimize the possibility of deleting a fragment that would and could have been resumed.

One technique is to delete the oldest fragments. However, this technique is not always the most efficient. For example, a fragment may be older than other fragments because it had taken a longer time to transfer (e.g., a large virtual disk file or a slow network connection). In this example, the transfer may be more likely to have resumption initiated given that the transfer took so much longer than other transfers.

An improved technique is to delete fragments that have a lower elapsed time. As discussed above, the elapsed time is stored as transfer metadata during the transfer and it may be included in the fragment record. The improved technique is based on both age and elapsed time. Elapsed time is used, not the size of the disk, such that both disk size and transfer speed are accounted for. To determine which fragments to delete from the fragment storage a list of the fragments may be sorted by age and then grouped into age brackets (gradations of ages). The fragments within the group may then be sorted by elapsed time. A certain portion of the fragments in the oldest age group that have the shortest elapsed time may be selected for deletion. The amount of free space in the fragment storage (e.g., based on an administratively allocated amount of space for fragment storage) may be used as a criterion for selecting how many fragments to evict. This selection and deletion process may occur when the fragment storage reaches are predetermined level or it may happen when the storage space allocated to the fragment storage changes (e.g., an administrative change).

### 6. Sparse Disk Virtual Disk Format

Certain virtual disks may be formatted using a “flat” format where logical representation of the disk and physical representation of the disk are the same. The disadvantage of flat formats is that the virtual disk takes up the entire amount of physical space as is allocated to the virtual disk. For example, a 2 TB flat virtual disk takes up 2TB of space whether there is 2 TB of data stored in the virtual disk or only 10 GB of data stored.

One alternative virtual disk format is “sparse disk” which has storage space advantages compared to flat disks as it only uses as much physical storage as stored used on the virtual disk. For example, if 10 GB of data is stored on a 2 TB virtual disk then only 10 GB of physical space is used to store that data (compared to 2 TB for the flat disk format), in addition to a fixed amount of data used to store a header and grain table, which are described below.

Resuming transfer of virtual disks stored using the flat format may be simpler as the logical representation of the disk and physical representation of the disk are the same. However, resuming transfer of virtual disks formatted using sparse disk is more complicated given that the logical representation of the disk is not the same as the physical representation of the disk. Another complication is that transferred grains could be stored in a different order because they are read in one order and they may be written according to a different transfer order. The above techniques for resuming virtual disk transfer based on the offset are crucial for resuming transfer of virtual disks stored in formats where the logical representation of the disk is different from the physical representation of the disk, as with sparse disk.

FIG. 6 depicts a conceptual diagram 600 of a sparse disk format for virtual machines, according to certain embodiments. Sparse disks use “grains” as a unit of storage. A grain is a group of blocks allocated in a single operation. A virtual disk formatted using sparse disk includes a header 610, a grain table 620, and grain data 630. Header 610 and grain table 620 are a fixed length depending on the amount of data allocated to the virtual disk (e.g., 2 TB). Header 610 comprises information such as the block size of the disk. Grain table 620 is a fixed area that is pre-allocated when the sparse disk is created. The entries in grain table 620 point to individual grains in the grain data. For example, entry 621 points to grain 631 and entry 622 points to entry 632 as shown in FIG. 6. Grain data 620 includes “grains” comprising a certain number of blocks of data, such as 16 blocks for 64 kb total with a block size of 4 kb. In other examples a grain in grain data 630 could comprise 1 MB of data.

In the sparse disk format, when a new block is written, typically a new grain is allocated and blocks are written to that grain. When the grain runs out of space, a new grain is allocated and new blocks are written. The last grain entry in the grain table points to the last grain on the disk. This pointer points to a place on physical media where the data of the grain is stored. To read/write from a sparse disk, the grain table is accessed to obtain an offset into the grain data. The grain table is organized in logical order. By using the grain table and allocating grains as needed, the portions of the virtual disk that have not been written are not physically part of the sparse disk. As mentioned above, writing to a sparse disk uses two separate writes: a write to grain data and an update to the grain table. Because of these two writes, when a mobility/transfer operation fails, it may be in a situation where one of the writes succeed and another one did not. In cases where the virtual disk is formatted using a format that requires multiple writes such as the sparse disk format, these writes are determined to succeed after all writes have completed (e.g., the grain table has been written and the grain data has been written). For this reason, the metadata of the transfer, including the offset, are updated after both writes have succeeded. For sparse disks, this guarantees that grain data is present and that there is no garbage data at the end of the virtual disk.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving one or more portions of a virtual disk in a data transfer from a source system, the virtual disk being a copy of a source virtual disk stored at the source system;
storing metadata based on the one or more portions of the virtual disk received from the source system, the metadata including an offset;
determining that the data transfer of the virtual disk from the source system failed;
creating a fragment record based on the metadata, the fragment record including an identifier of the source virtual disk, the offset, and an identifier of a virtual disk fragment including the one or more portions of the virtual disk;
receiving a request to resume the data transfer of the virtual disk, the request including the identifier of the source virtual disk;
sending a response to resume the data transfer of the virtual disk, the response including the offset; and
resuming the data transfer of the virtual disk copy based on the offset.

2. The method of claim 1 wherein the offset is updated during the receiving of the one or more portions of the virtual disk, and wherein the offset is updated to a number of logical blocks of the one or more portions of the virtual disk that have been received.

3. The method of claim 1 wherein the receiving of the one or more portions of the virtual disk includes receiving data for an additional portion of the virtual disk beyond the one or more portions, wherein the virtual disk fragment further includes the additional portion, and wherein the method further comprises:
truncating the virtual disk fragment including the one or more portions and the additional portion based on the offset to obtain a truncated virtual disk fragment including the one or more portions and not including the additional portion.

4. The method of claim 3 wherein the truncating of the virtual disk fragment is performed after the determining that the data transfer failed and before the receiving of the request to resume the data transfer.

5. The method of claim 3 wherein the truncating of the virtual disk fragment is performed after the receiving of the request to resume the data transfer.

6. The method of claim 1 further comprising:
preserving the virtual disk fragment.

7. The method of claim 1 wherein the fragment record of the virtual disk includes a content identifier, wherein the request includes a request identifier, and wherein the method further comprises:
verifying the request identifier of the request by matching it with the content identifier of the virtual disk.

8. The method of claim 7 further comprising:
storing the virtual disk fragment including the one or more portions of the virtual disk; and
retrieving the virtual disk fragment in response to verification of the request.

9. The method of claim 8 further comprising:
wherein the virtual disk fragment is stored in a fragment storage and is retrieved from the fragment storage.

10. The method of claim 1 further comprising:
receiving a second request to resume a second data transfer, the second request including a second identifier of a second virtual disk fragment and a second content identifier of a second source virtual disk;
identifying the second virtual disk fragment based on the second identifier, the second virtual disk fragment having a third content identifier different from the second content identifier, the second content identifier of the second source virtual disk being different from the third content identifier of the second virtual disk fragment indicating that second source virtual disk has been modified; and
deleting the second virtual disk fragment based on the third content identifier being different from the second content identifier.

11. The method of claim 1 wherein the virtual disk is formatted in a sparse disk format and includes a header, a grain table comprising a plurality of entries, and grain data comprising a plurality of grains of data, each entry in the grain table pointing to a particular grain in the grain data.

12. A non-transitory computer readable storage medium having stored thereon program code executable by a computer system, the program code embodying a method comprising:
receiving one or more portions of a virtual disk in a data transfer from a source system, the virtual disk being a copy of a source virtual disk stored at the source system;
storing metadata based on the one or more portions of the virtual disk received from the source system, the metadata including an offset;
determining that the data transfer of the virtual disk from the source system failed;
creating a fragment record based on the metadata, the fragment record including an identifier of the source virtual disk, the offset, and an identifier of a virtual disk fragment including the one or more portions of the virtual disk;
receiving a request to resume the data transfer of the virtual disk, the request including the identifier of the source virtual disk;
sending a response to resume the data transfer of the virtual disk, the response including the offset; and
resuming the data transfer of the virtual disk copy based on the offset.

13. The non-transitory computer readable storage medium of claim 12 wherein the offset is updated during the receiving of the one or more portions of the virtual disk, and wherein the offset is updated to a number of logical blocks of the one or more portions of the virtual disk that have been received.

14. The non-transitory computer readable storage medium of claim 12 wherein the receiving of the one or more portions of the virtual disk includes receiving data for an additional portion of the virtual disk beyond the one or more portions, wherein the virtual disk fragment further includes the additional portion of the virtual disk, and wherein the method further comprises:
truncating the virtual disk fragment including the one or more portions and the additional portion based on the offset to obtain a truncated virtual disk fragment including the one or more portions and not including the additional portion.

15. The non-transitory computer readable storage medium of claim 14 wherein the truncating of the virtual disk fragment is performed after the determining that the data transfer failed and before the receiving of the request to resume the data transfer.

16. The non-transitory computer readable storage medium of claim 14 wherein the truncating of the virtual disk fragment is performed after the receiving of the request to resume the data transfer.

17. The non-transitory computer readable storage medium of claim 12 wherein the fragment record of the virtual disk include a content identifier, wherein the request includes a request identifier, and wherein the method further comprises:
verifying the request identifier of the request by matching it with the content identifier of the virtual disk.

18. The non-transitory computer readable storage medium of claim 17 wherein the method further comprises:
storing the virtual disk fragment including the one or more portions of the virtual disk in a fragment storage; and
retrieving the virtual disk fragment from the fragment storage in response to verification of the request.

19. The non-transitory computer readable storage medium of claim 12 wherein the method further comprises:
receiving a second request to resume a second data transfer, the second request including a second identifier of a second virtual disk fragment and a second content identifier;
identifying the second virtual disk fragment based on the second identifier, the second virtual disk fragment having a third content identifier different from the second content identifier; and
deleting the second virtual disk fragment based on the third content identifier being different from the second content identifier.

20. A computer system comprising:
a processor; and
a non-transitory computer readable medium having stored thereon program code for causing the processor to:
receive one or more portions of a virtual disk in a data transfer from a source system, the virtual disk being a copy of a source virtual disk stored at the source system;
store metadata based on the one or more portions of the virtual disk received from the source system, the metadata including an offset;
determine that the data transfer of the virtual disk from the source system failed;
create a fragment record based on the metadata, the fragment record including an identifier of the source virtual disk, the offset, and an identifier of a virtual disk fragment including the one or more portions of the virtual disk;
receive a request to resume the data transfer of the virtual disk, the request including the identifier of the source virtual disk;
send a response to resume the data transfer of the virtual disk, the response including the offset; and
resume the data transfer of the virtual disk copy based on the offset.
